(19) United States
(12) Patent Application Publication
(10) Pub. No.: US 2026/0083622 A1
(43) Pub. Date: Mar. 26, 2026

(54) INTERMITTENT PNEUMATIC COMPRESSION DEVICE

(71) Applicant: Kerry and Kathryn Logan, Lafayette, IN (US)

(72) Inventors: Kerry Logan, Laafayette, IN (US); Kathryn Logan, Lafayette, IN (US)

(21) Appl. No.: 19/408,830

(22) Filed: Dec. 4, 2025

Related U.S. Application Data
(63) Continuation of application No. 16/419,582, filed on May 22, 2019, now abandoned.

(51) Int. Cl. A61H 9/00

(52) U.S. Cl. CPC A61H 9/0092; A61H 2201/0192; A61H 2201/1638; A61H 2201/1642; A61H 2201/5012; A61H 2201/5015; A61H 2201/5035; A61H 2201/5046; A61H 2201/5097; A61H 2209/00

(57) ABSTRACT

An intermittent pneumatic compression (IPC) device includes a user interface allowing selection among different categories of circulation insufficiency. After one of the categories is selected the possible range for the treatment parameters are limited. The disclosed device includes an intermittent pneumatic compression device that has lockable, adjustable treatment parameters. A lockout mechanism activates after selection of the parameter values, preventing the patient from changing the selected values. The lockout mechanism requires an access device to make further changes to the values. An inflatable cuff for the foot includes both a zipper and hook-and-loop fasteners to maintain tension during compression and wherein the zipper can be opened to remove said cuff while preserving the hook-and-loop fastener relationship so that when the cuff is placed back into position and the zipper closed, the fixed adjustable dimension of the combination will be restored.

### CROSS-REFERENCE TO RELATED APPLICATION

This application is a continuation of U.S. application Ser. No. 16/419,582, filed on May 22, 2019, the entire disclosure of which is hereby incorporated by reference.

### BACKGROUND

Peripheral vascular disease (PVD) is a slow and progressive circulation disorder. It may involve disease in any of the blood vessels outside of the heart and diseases of the lymph vessels—the arteries, veins, or lymphatic vessels. Organs supplied by these vessels such as the brain, heart, and legs, may not receive adequate blood flow for ordinary function. However, the legs and feet are most commonly affected, thus the name peripheral vascular disease. Conditions associated with PVD that affect the veins include deep vein thrombosis (DVT), varicose veins, and chronic venous insufficiency. Lymphatic insufficiency or lymphedema is an example of PVD that affects the lymphatic vessels. When PVD occurs in the arteries outside the heart, it may be referred to as arterial insufficiency, or the most common type known as peripheral arterial disease (PAD).

There are about 8 million Americans that suffer from PAD. PAD is caused by restriction in arterial flow to the limbs and results in pain when the body can't get needed resources. The largest group of the overall population to get PAD is older, likely diabetic and often with other complicated health issues. The non-amputation surgical solution is often an arterial graft, which has surgical and recovery complications. For this large group a preferred non-invasive alternative is an Intermittent Pneumatic Compression (IPC) device. An IPC device basically works like a large milking machine, intermittently squeezing on the limb to help circulation. There are several physiologies that occur. The rapidness of the compression simulates muscle contraction like exercise. This creates a chemical response in the limb that tends to develop vascular pathways that ideally can have positive long-term effects. The actual compression tends to empty out the blood in the veins. This reduces venous pressure encouraging arterial blood to empty and return faster. There is also an effect on the lymphatic system as it may enhance draining lymphatic fluid through tissue and nodes to the veins. IPC devices can also enhance wound healing.

The severe condition of PAD is critical limb ischemia (CLI), which affects an estimated 1.1 million Americans and occurs when arterial circulation is so bad it can cause ulcers in the limbs. After 6 months of reaching the CLI stage the mortality rate is 20%. According to The Sage Group, 160,000 PAD related amputations per year are performed in the US. In 60-70% of the CLI amputees, amputation was the first procedure to be performed. Even after surviving the first amputation, the mortality rate is 40% after just 2 years. A second amputation follows 30% of the time with full mobility only being restored 50% of the time. These figures do not consider persons suffering from venous ulcers or lymphedema (swelling) and countries outside the United States, or that the senior citizen population is growing faster than the general population.

Another circulatory condition is Lymphedema. Lymphedema, also known as lymphatic obstruction, is a condition of localized fluid retention and tissue swelling caused by a blockage in the lymphatic system, an important part of the body's immune and circulatory systems. The blockage prevents lymph fluid from draining well, and as the fluid builds up, the swelling continues. Lymphedema is most commonly caused by the removal of or damage to lymph nodes as a part of cancer treatment.

Treating these various circulatory ailments is a major concern within the vascular disease community. Currently, these ailments may only be treated by using 3-4 different devices. The equipment necessary to treat these diseases can be expensive and take up vast amounts of space in a room or clinic.

Our earlier U.S. Pat. No. 9,615,991, which is hereby incorporated by reference, disclosed a system that achieved very rapid rises in pressure for compression while inherently preventing severe overpressures in any failure mode.

An ongoing issue with current devices is patient safety. Current devices allow for users to adjust the settings without safety mechanisms to ensure patient safety and compliance with a prescription in clinical or at home models.

Due to these various issues, there is a need for improvement in this field.

### SUMMARY

The claims, and only the claims, define the invention. Thus, the invention comprises all of the differences from the above described prior art that would not have been obvious to a person of ordinary skill in the art at the time we made our invention, and as are more particularly set forth in the claims. Merely by way of partial example, in certain aspects the present invention provides unique intermittent pneumatic compression (IPC) devices for facilitating fluid circulation in a body by alternating between a higher pressure and a lower or no pressure in an associated inflatable cuff. In accordance with some forms of the invention, the IPC device allows for treatment of at least three circulation insufficiencies, selected by category. In some embodiments, one may select from four categories of circulation insufficiencies for treatment by a single device. A preferred version of the device includes a user interface allowing for selection among different categories of circulation insufficiency, including (1) arterial insufficiency, (2) venous insufficiency, (3) lymphatic insufficiency or (4) deep vein thrombosis. In one embodiment, the user interface is a touchscreen integrated into an electric visual display. Preferably the device is capable of a wide range of treatment for each of the treatment parameters of air pressure, pulse duration and pulse gap duration or total cycle time. An authorized user (i.e. setup person) may select a category of circulation insufficiency and when one of the categories is selected, the wide range of treatment possibilities for the treatment parameters are limited to a range that may effectively treat the selected category of circulation insufficiency. None of the limited treatment parameter ranges for an individual circulation insufficiency category is identical to that of any other disease category for all of the treatment parameters.

Additionally, certain versions of the device include a lockout mechanism to ensure patient compliance and safety. These versions of the device include lockable, adjustable settings. For such devices, an authorized setup person uses an access device to unlock the adjustable treatment parameter function. In various embodiments, the lockout mechanism may be accessed through a Universal Serial Bus (USB) or remotely through a wireless pathway, such as WIFI or cell phone services. Once access is granted, the authorized setup person may select a category of circulation insufficiency or specific value for each treatment parameter. Once the treatment parameters are selected, the authorized setup person engages the lockout mechanism. The lockout mechanism prevents anyone but an authorized user from adjusting the settings on the device. After the lockout mechanism is engaged, the patient may begin treatment.

Lastly, an inflatable cuff for an intermittent pneumatic compression device is disclosed. The cuff includes a hook-and-loop fastener for adjusting the tension of the inflatable cuff, a zipper for releasing said tension without altering the hook-and-loop fastener relationship, so that the cuff may be temporarily removed by opening the zipper and later restored to position by closing the zipper with the initially set tension achieved by the hook-and-loop fastener being substantially restored. Additionally, as an aid to mobility, the large air hose connection to a cuff for use on the foot can be positioned away from the underside of the foot so as to allow limited walking or standing while being connected to the apparatus.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view showing an illustrative embodiment of an intermittent pneumatic compression device attached to the patient.

FIG. 2A is a front view of an embodiment of the user interface suitable for use in the clinical model used with the intermittent pneumatic compression device shown in FIG. 1.

FIG. 2B is a front view of an alternative embodiment of the user interface suitable for use in the clinical model used with the intermittent pneumatic compression device shown in FIG. 1.

FIG. 2C is a front view of yet another alternative embodiment of the user interface suitable for use in the at-home model used with the intermittent pneumatic compression device shown in FIG. 1.

FIG. 3 is a top view of the intermittent pneumatic compression device shown in FIG. 1.

FIG. 4 is a flowchart illustrating one embodiment of the adjustable programming of the intermittent pneumatic compression device of FIG. 1.

FIG. 5 is a flowchart illustrating the lockout mechanism of the intermittent pneumatic compression device of FIG. 1.

FIG. 6 is a side view of an embodiment of the inflatable cuff which could alternatively be used in place of the cuff shown in FIG. 1.

FIG. 7 is a rear view of an embodiment of the inflatable cuff of FIG. 6.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. Some embodiments of the inventions are shown in some degree of detail, although it will be apparent to those skilled in the relevant art that some features not relevant to the present invention may not be shown for the sake of clarity.

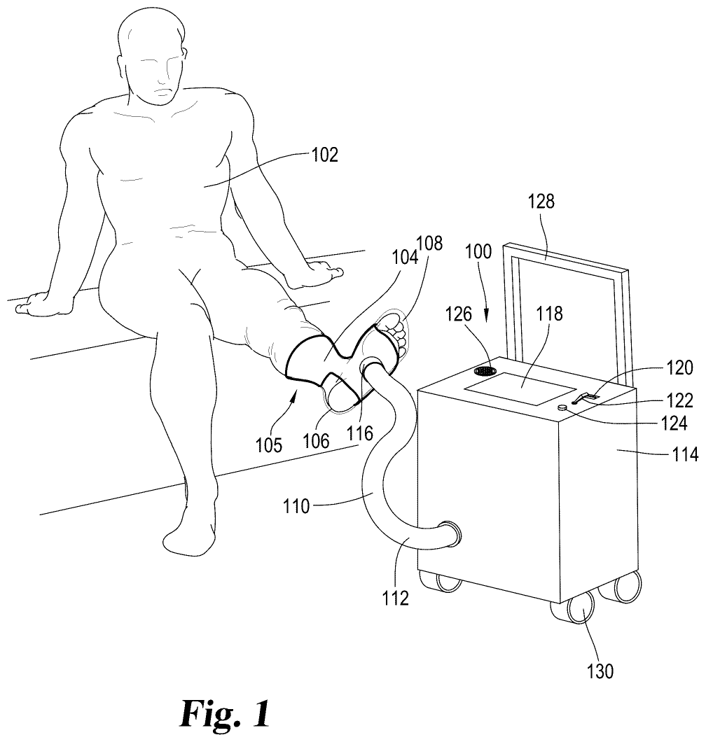

FIG. 1 depicts an illustrative environmental example of the IPC device 100 according to one embodiment. The inflatable cuff 104 is being worn on a patient's 102 extremity. The patient 102 is depicted in a sitting, partially reclined position with the treated leg elevated to a substantially horizontal position. It is understood that the patient's 102 treated extremity may be rested on a structure such as a footrest. It is seen that the inflatable cuff 104 is formed to surround and cover the foot and calf regions of the involved leg of the patient 102. The precise extent of the body regions in contact with the cuff 104 may vary depending upon the type of condition being addressed and the location of the affected body region. The cuff 104 may be lined with foam in order to ensure the compressions contribute minimal ambient noise. It should also be appreciated that many forms of conventional inflatable cuff designs may be readily adapted for use with the IPC device 100, and therefore more detailed aspects of the cuff 104 design including but not limited to size, shape, materials, forms of attachments, etc., are therefore omitted for sake of clarity. While a calf and foot cuff 104 is shown for illustration, other cuffs are envisioned to be equally suitable for other extremities as well, such as for a calf alone, a foot alone, thigh, arm, hand, finger or toe, for examples.

As shown, minor portions of the inflatable cuff 104 are see-through portions 106 and 108 permitting visibility of the wearer's toes and heel during operation of the device for enhanced safety considerations. See-through portions 106 and 108 may for example be formed of a 4 mm clear flexible plastic material. The inflatable cuff 104 shown is a single-chamber bladder design adapted to treat arterial flow insufficiencies. The IPC device 100 may also be adapted to: have a multi-chambered bladder for sequential inflation/deflation of the chambers such as may for example be desired to treat venous or lymphatic conditions.

For sanitation purposes, patient 102 may preferably wear a glove 105 on the extremity receiving treatment. The term glove as used herein is intended to encompass, for examples, a sock when used on a foot or a hand glove or mitten when used on a hand or arm. This may reduce the need to clean or replace the cuff 104 after every treatment, especially in a clinical setting. The patient may receive one washable, reusable glove 105 when they begin treatment or the glove 105 may be disposable after a one-time use. The glove 105 may be made of a thin and flexible material so as to not interfere with the treatment's effectiveness. As one example, the glove 105 may be made of nitrile, which can be relatively incompressible in this application. The glove 105 optionally may be lined with a sufficiently thin layer of felt or felt like material that it does not interfere with the treatment's effectiveness yet improves patient comfort. The glove 105 may come in various sizes to meet patient needs. As illustrated in FIG. 1, the IPC device 100 is often used on a patient's 102 leg. The sock-shaped glove 105 may have see-through portions to match see-through portions 106 and 108 of the cuff 104. The glove 105 may have an elastic band to help anchor it to the patient's 102 body. This will help avoid the glove 105 slipping down a patient's 102 leg during operation and exposing the skin to the cuff 104. Although discussed as an elastic band, the glove 105 may be held in place by any suitable material or method, including adhesives. While a treatment of a foot is discussed for illustrative purposes, the glove 105 is envisioned to be equally suitable for other extremities as well, such as for a calf alone, a foot alone, thigh, arm, hand, finger or toe, for examples. The glove 105 may be manufactured to conform to any extremity.

Extending from the bottom of the cuff 104 on the underside of the wearer's foot is a 1.5 inch diameter flexible hose 110 forming the passageway 112 that communicates between the cuff 104 and low air pressure source contained within housing or console 114. The flexible hose 110 may be connected to the inflatable cuff 104 by a quick-disconnect swivel coupling 116. The swivel coupling 116 may come in an L-shaped configuration. Alternatively to the underside of the foot, other points of attachment of hose 110 may be chosen if desired, so as to enable standing or limited walking while in use. The housing 114 is preferably designed to be portable for home use, although larger professional and clinical versions are also contemplated. In order to make the IPC device 100 portable, a handle 128 and wheels 130 were added to the device. The handle 128 and wheels 130 make the IPC device 100 easier to maneuver and store. The patient may wheel the IPC device 100 and place it in the corner, in a closet, under the bed, etc. when not in use. The handle 128 may be preferably retractable or it may be fixed.

Suitable operator controls (e.g., power switch, pressure selector control), indicators, gauges, and/or other operator information and controls are conveniently provided on the top of the housing 114. As an alternative, these functions may simply be programmed to be part of an input/output (I/O) device or user interface 118 that is a touch screen display located on top of the housing 114. Applicant envisions these controls may be placed anywhere on the housing 114 A user interface 118 could include a keyboard, mouse, trackball, and/or touch sensitive pointing device, etc. In one preferred embodiment, the user interface 118 is a touchscreen integrated into an electronic visual display. Alternatively, if designed as an at-home device for a specific affliction such as for example arterial insufficiency, it may help avoid operator error to provide only an on/off power control 122 and thus require no control changes/adjustments on the part of the home patient. While shown here with a user interface 118 associated with the housing 114, applicants' also envision an alternative embodiment that puts controls and displays of operating parameters and settings additionally or alternatively on a wireless, hand-held remote control. A key port 120, power control 122, indicator light 124 and speaker 126 are included on top of the housing 114. The key port 120 allows for an authorized user to program the device for use. In a preferred embodiment, the key 121 used with key port 120 is a Universal Serial Bus (USB) device. Power control 122 allows the patient to turn the IPC device's 100 power on or off. Although depicted as a power toggle, the power control 122 can be a button, dial, knob, etc. Indicator light 124 shines when power is being provided to the IPC device 100. Additionally, speaker 126 is included to provide various commands or updates to the patient. The speaker 126 helps patients that have poor eyesight operate the IPC device 100.

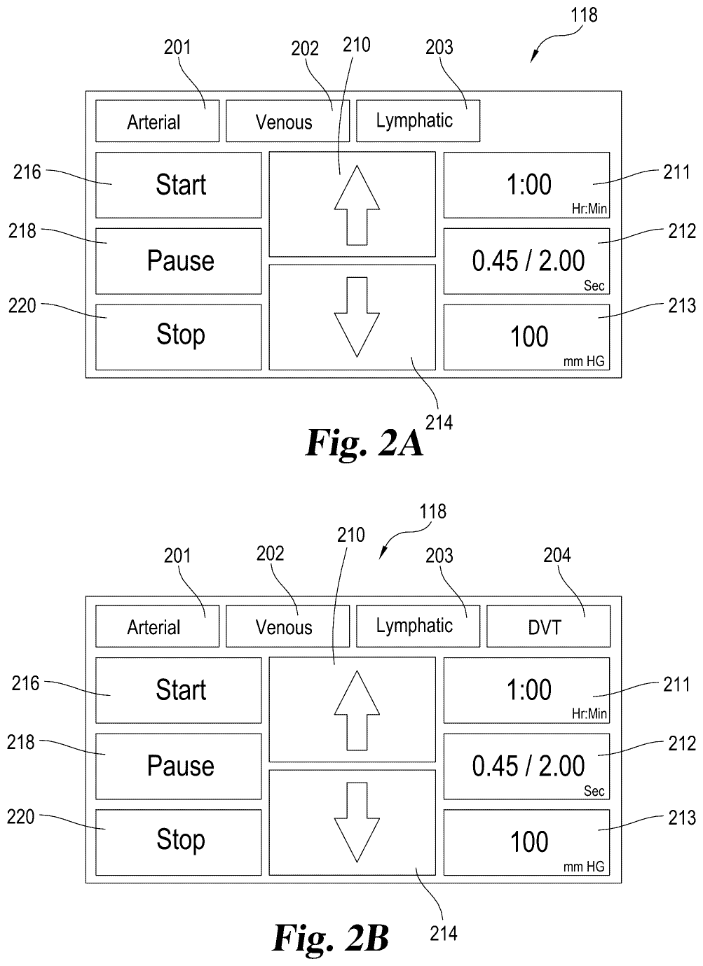

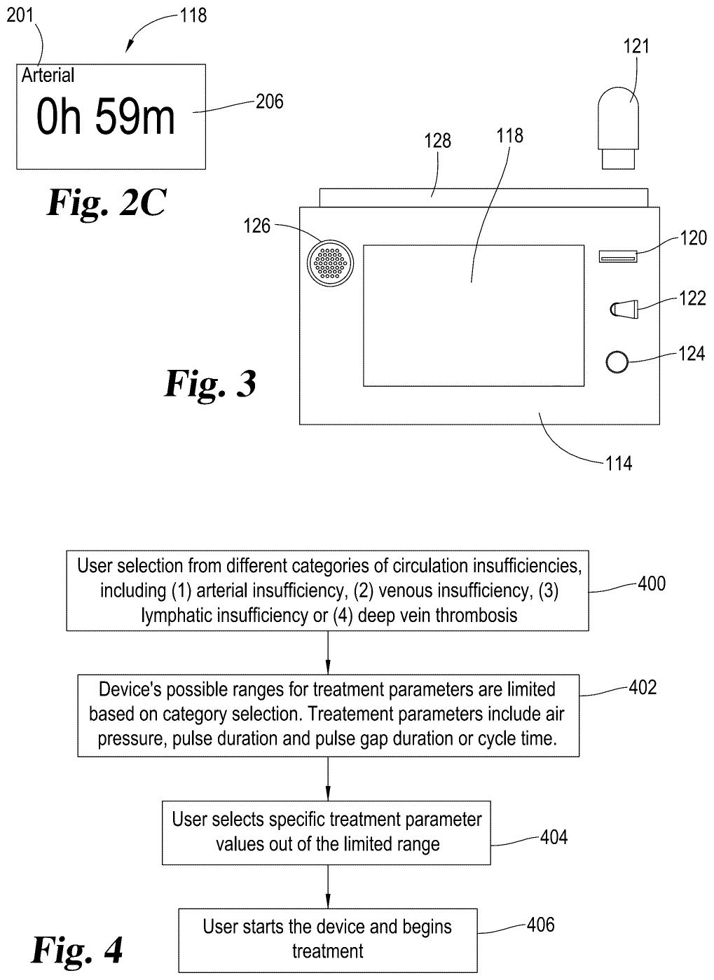

FIGS. 2A-C illustrate three alternative embodiments of the user interface 118 of FIG. 1. While all three are illustrated as touchscreens integrated into an electronic visual display for simplicity, applicants do not limit themselves to any one user interface structure. In the example shown in FIGS. 2A and 2B, the user interface 118 is displayed in the clinical mode, wherein the person performing the setup for the machine is the clinician or another authorized setup individual at the clinic. However, it should be appreciated that these displays may be used on the at-home models as well. FIG. 2C represents a third alternative user interface 118 displayed for at-home use. Again, this user interface 118 display is not limited to the at-home mode.

FIG. 24 depicts the user interface 118 of the IPC device 100. While shown here with one embodiment of the user interface 118 display, applicants' also envision operating the various arrangements of the display by touching the control icon locations. In one embodiment, the user interface 118 displays three different categories of circulation insufficiencies. For illustrative purposes only, category one 201 is demonstrated as arterial insufficiency, category two 202 is shown as venous insufficiency and category three 203 is shown as lymphatic insufficiency. However, it should be understood that the three categories can be any combination of disease conditions. Most preferably the following four circulation insufficiencies are the disease conditions defined by four categories: (1) arterial insufficiency, (2) venous insufficiency, (3) lymphatic insufficiency or (4) deep vein thrombosis.

In FIG. 2A, the user interface 118 includes the settings for the treatment parameters. The treatment parameter displays one through three are shown in 211, 212 and 213, respectively. For illustrative purposes treatment parameter one 211 is shown as total treatment time with the hours and minutes still remaining. Total treatment time may be altered depending on the treatment time required for the patient's disease. Treatment parameter two 212 is shown as the duration of each pulse/total cycle time. The first number is the time of the air pulse. The second number is the time of the air pulse plus the pulse gap duration, otherwise known as total cycle time. The duration of each pulse and cycle time can be adjusted depending on the patient's disease. Treatment parameter three 213 is depicted as the air pressure for each pulse. The pressure of each pulse may be adjusted between 20 to 130 mm Hg depending on the disease being treated. In order to adjust the various treatment parameters, adjustment controls 210 and 214 are provided. In a preferred embodiment, the adjustment controls 210 and 214 are an up and down arrow icons to indicate whether the authorized user is increasing or decreasing the treatment parameter's value. Applicant envisions embodiments where the adjustment controls 210 and 214 are for examples, knobs, buttons, slider images on a touch screen, or any other variation to allow treatment parameter adjustment up or down. Additionally, a start icon 216, a pause icon 218 and a stop icon 220 are located on the user interface 118. When the patient or other user selects start icon 216, pause icon 218 or stop icon 220, the selected icon becomes larger than the other two icons. The start icon 216 allows the patient or other user to begin or: resume treatment by simply touching the icon. The pause icon 216 enables the patient or other user to pause treatment without requiring them to start treatment from the beginning. Pausing allows the patient to perform various activities, such as going to the restroom that would otherwise be cumbersome if not impossible while the device is in use. The patient or other user simply touches the pause icon 218 and the treatment temporarily stops. Once the patient or other user desires to continue treatment they select the start icon 216 and the IPC device 100 continues treatment for the remaining treatment time. Although various fail safes have been programmed into the device, a stop icon 220 is provided. The patient or other user may select the stop icon 220 to terminate treatment for any reason.

FIG. 2B depicts another embodiment of the user interface 118 of the IPC device 100. All of the FIG. 2a discussion applies to FIG. 2b. FIG. 2b adds category four 204 to the user interface 118. For illustrative purposes category four 204 is shown as DVT. In this embodiment, a total of four circulation insufficiencies are included on the user interface 118.

FIG. 2C depicts the user interface 118 with treatment parameter one 211 and category one 201 displayed as icons. In a preferred embodiment, treatment parameter one 211 is the remaining treatment time and category one 201 is the disease being treated. The user interface 118 is designed to be more simplistic in the at-home mode to increase patient safety and to ensure the device is easy to operate. Additionally, due to the advanced age of the typical patient inflicted by these diseases, applicant chose to enlarge the time remaining for patients with poor eye sight. To start treatment, the patient simply taps anywhere on the screen. Due to possible treatment times lasting for several hours, applicant anticipated that patients may need to pause treatment to use the restroom or perform other activities. In order to pause the machine, patient may simply touch anywhere on the screen and the device will pause treatment. Once a patient returns to continue treatment, the patient may again tap anywhere on the screen to restart treatment from the time of stoppage.

FIG. 3 depicts a top view of the IPC device 100. The retractable handle 128 is shown at the upper part of the drawing. The housing 114 is shown with the user interface 118. The housing 114 includes a key port 120. In one embodiment, the key port 120 is configured to receive a key 121 in the form of a suitably programmed USB flash drive. As will be described in greater detail below, an authorized setup person inserts the key 121 into the key port 120. Once the key 121 has been inserted and a password provided, the authorized setup person may: program the parameter settings for desired treatment. A power control 122 is provided to allow the patient to turn the IPC device 100 on and off. When the power for the IPC device 100 is turned on, indicator light 124 glows a preset color. The indicator light 124 informs the patient that the power to the IPC device 100 is turned on. The indicator light 124 can be helpful to patients with hearing disabilities or patients that are not technologically savvy. Further provided on the housing 114 is a speaker 126. Speaker 126 may be turned on or muted depending on the desired mode of operation. When speaker 126 functions are activated, the speaker 126 may provide a number of commands or updates to the patient. The commands may include: “shutting down”, “uploading memory”, “insert memory storage device”, “treatment completed”, etc.

FIG. 4 depicts a flowchart illustrating one embodiment of the adjustable programming of the IPC device 100. The IPC device 100 simplifies treatment of any one of at least three different diseases by one device by the selection of an appropriate category. When setting up the device an authorized user (i.e. setup person) preferably selects from different categories of circulation insufficiency, including (1) arterial insufficiency, (2) venous insufficiency, (3) lymphatic insufficiency or (4) deep vein thrombosis 400. The IPC device 100 may provide the authorized user with at least three options for treatment. Once a category is selected, the device's possible ranges for treatment parameters are limited based on the category selected. The possible ranges for all of the treatment parameters for one category do not match any other category. The treatment parameters may include, for examples, air pressure, pulse duration, pulse gap duration, and/or cycle time. 402. The authorized user (i.e. setup person) may select specific treatment parameter values out of the limited range for the category selected 404. After all of the treatment parameters are set, the patient may start the IPC device 100 and begin treatment 406.

The following table shows the IPC device's 100 preferred software controlled ranges for each treatment parameter in the preferred embodiment:

| | | |
|---|---|---|
| Air Pressure (mm HG) | 30-120 | (hardware cap at 130) |
| Pulse Duration (seconds) | 0.2-.8 | (hardware cap at 1) |

| | |
|---|---|
| Total Cycle Time (seconds) | 1.2-5 |

The IPC device 100 preferably has a built in hardware fail-safe that allows for a maximum air pressure of less than 130 mm Hg and a maximum compression time of less than 1 second. The hardware fail-safe for maximum pressure is inherently the result of the use of a centrifugal blower used to create the air pressure, and the time fail safe is built into the controlling software. The hardware fail-safe helps prevent injuries to the patient during treatment.

The following table shows the treatment parameter ranges for each category of circulation insufficiency:

| | Arterial | Venous | Lymphatic | DVT |
|---|---|---|---|---|
| Air Pressure | 80-120 | 60-100 | 30-60 | 30-60 |
| (mm HG) | | | | |
| Pulse Duration | .35-.55 | .45-.6 | .6-.8 | .6-.8 |
| (seconds) | | | | |
| Total Cycle Time | 1-5 | 1-5 | 1-5 | 1-5 |
| (seconds) | | | | |
| Periodic Pauses | No | No | No | Yes |

The second table provides the default treatment parameter settings for each category of circulation insufficiency:

| | Arterial | Venous | Lymphatic | DVT |
|---|---|---|---|---|
| Air Pressure | 100 | 80 | 46 | 46 |
| (mm HG) | | | | |
| Pulse Duration | .45 | .52 | .7 | .7 |
| (seconds) | | | | |
| Total Cycle Time | 2 | 2 | 3 | 3 |
| (seconds) | | | | |
| Total Treatment | 1:00 | 2:00 | 3:00 | 3:00 |
| Time (hours) | | | | |
| Periodic Pauses | No | No | No | Yes |

The treatment of deep vein thrombosis requires repeating the total cycle three times in a row and then pausing for a period of time longer than the combined time of the three repeating cycles. Preferably the period is five times longer than the combined time of the three repeating cycles. During the pause, the IPC device's 100 blower may turn off to lower the ambient noise level.

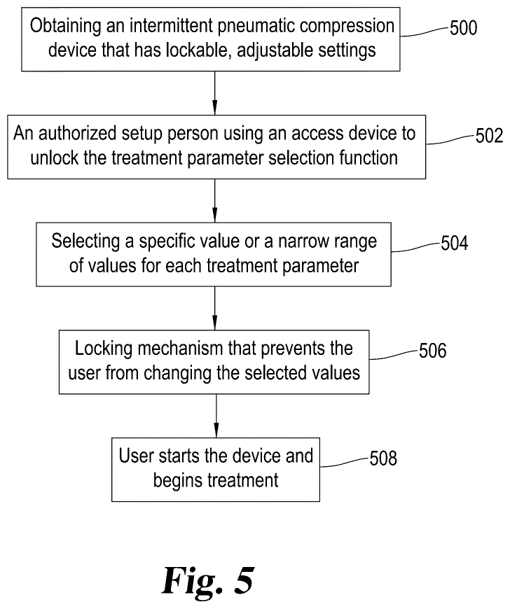

FIG. 5 illustrates the lockout mechanism of the IPC device 100. The lockout mechanism can be used on any IPC device. Preferably, an IPC device 100 with lockable, adjustable settings is used 500. An authorized setup person uses an access device/key 121 to unlock the lockout mechanism. The lockout mechanism may be accessed with a key 121 in the form of a suitably programmed USB flash drive or through a wireless pathway. The wireless pathway may include cellular data, Bluetooth, Wi-Fi or any other internet pathway. A two factor authentication mechanism may be employed for unlocking to further strengthen the system's security. Once the PIC device 100 is unlocked, the treatment parameter selection function of the device may be manipulated 502. Once the key 121 is inserted, the device checks that the key 121 is encrypted. After the key 121 is accepted, a password is required to adjust the parameter settings of the device. Although not required, the device may prompt the authorized setup person to enter a nonidentifiable patient number so that compliance data may be sent to a treating physician. Requiring a patient number is not vital to the lockout mechanism, but is helpful to ensure the patient privacy essential for FDA approval of the device. If the device is in at-home mode, the key 121 will provide the parameter settings to the device for treatment of one disease. Allowing the treatment of only one disease in the at-home mode reduces the risk of the patient accidentally changing the setting and becoming exposed to a potential injury from use of a protocol that differs from what has been prescribed by a physician or other treating professional.

After an authorized setup person has unlocked the device, the person is able to select a specific value or a narrow range of values for each treatment parameter 504. In some embodiments, after the range or category limiting the range is selected the authorized setup person can then select specific values for the treatment parameters. In other embodiments, the user interface 118 allows only selection of a specific value for each treatment parameter without selecting a category. A Bluetooth keyboard may be wirelessly connected to the IPC device 100 to assist with the at-home setup. Any suitable input device may be employed.

Once the treatment parameters have been set, a lockout mechanism engages preventing the patient from changing the treatment parameter values 506. As described above, an access device is necessary in order to unlock the device and make further changes to the treatment parameters. With the lockout mechanism engaged, the patient starts the device operations and begins treatment 508.

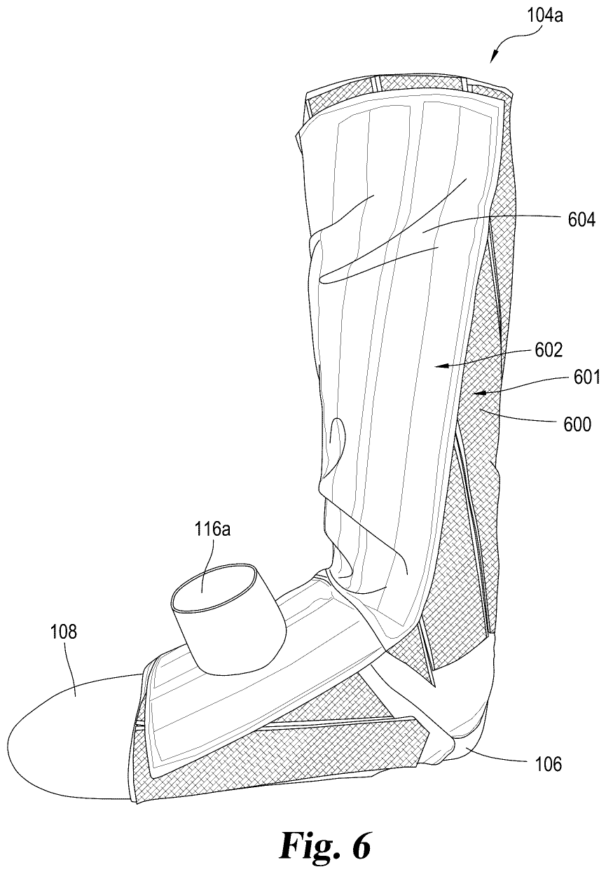

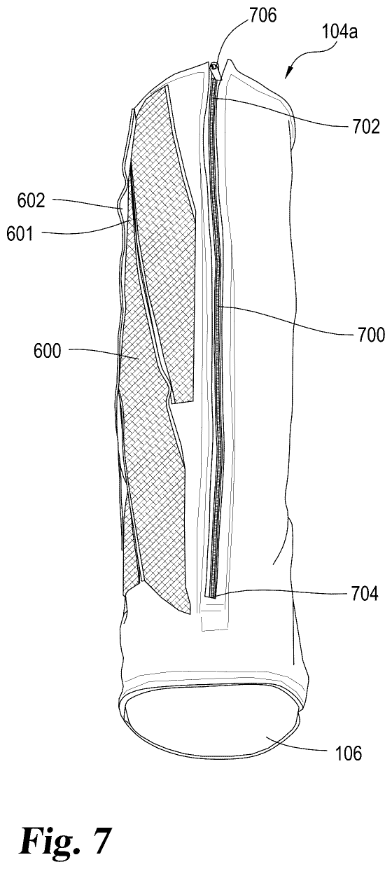

FIGS. 6 and 7 illustrate one preferred embodiment of an alternative inflatable cuff 104a that can be used in place of the cuff 104 of FIG. 1. The inflatable cuff 104a depicted is used to surround and cover the patient's foot and at least a portion of the calf region. Applicant used the combination of hook-and-loop fasteners 600, including hooks 601 and loops 602, and a zipper 700 to enable the patient to remove the boot without affecting the inflatable cuff's 104a tension or rigidity. In one example, the hook-and-loop fasteners 600 may be VELCRO®. The zipper 700 includes a top portion 702 and a bottom portion 704 with a slider 706. The term zipper as used herein can be any type of strong, simple-to-operate joining device(s) that can restore the tension after being opened for removal of the cuff 104a, and will reestablish the tension established by the hook-and-loop fasteners 600 after the cuff 104a is replaced. Examples would include, but are not limited to coil zippers, invisible zippers, metal zippers, open-ended zippers, magnetic zippers, a series of quick release buckles, etc.

As described above, the inflatable cuff 104a is lined with one or more inflatable bladders 604 inflated during treatment to provide pressure to the afflicted extremity. The inflatable cuff 104a may have a single-chamber bladder or multi-chambered bladder such as may be desired to treat the given condition. The inflatable cuff 104a includes see-through portions 106 and 108 permitting visibility of the wearer's toes and heel during operation of the device for enhanced safety considerations. The swivel coupling 116a for attaching the flexible hose 110 is depicted on top of the inflatable cuff 104a. This orientation allows the patient to lightly walk on the inflatable cuff 104a, thus, providing the patient with mobility during treatment. Applicant envisions other embodiments where the swivel coupling 116a is located on the underside or on the calf region of the inflatable cuff 104a.

Many circumferential portions of the cuff 104a around the patient's leg include at least a portion of the hook-and-loop fasteners 600 and the zipper 700. The hook-and-loop fasteners 600 and the zipper 700 preferably both operate independently of one another. This design allows the patient to adjust the hook-and-loop fasteners 600 to adjust the cuff 104a to fit the patient's extremity and adjust the tension or rigidity of the cuff 104a. If the patient has finished treatment or pauses treatment, perhaps to use the restroom, they may unzip the cuff 104a for removal without affecting the tension of the cuff 104a that will again be applied when the cuff 104a: replaced and zipped back up. Therefore, when they return to begin another treatment, the patient may simply zip up the cuff 104a and begin treatment without any need to readjust the hook-and-loop fasteners 600. When the hook-and-loop fasteners 600 and zipper are in an operable configuration, they jointly provide radial compression to the extremity.

In addition to all of the features laid out above, the applicant has developed software to help ensure patient compliance. Applicant's website is secured with one or more passwords and contains unidentifiable patient data using patient IDs. The website is an intermediate database that can be queried by authorized individuals. Prescriber and payer, such as Medicare, may retrieve compliance data through the website by using the patient's ID number. A clinician may be provided with a number, and by entering this number into the website can retrieve the data for all of their patients.

The device's software includes an overlay preferably on a Raspberry Pi brand computer so data on the operating system is not corrupted by an improper shut down. This allows the device to save volatile temporary operating system (OS) data to an internal memory drive instead of long-term storage. Therefore, an unforeseen event such as a power failure will not corrupt the treatment data. This overlay is capable of storing volatile memory for approximately a year of home use without turning off the device. Once the IPC device 100 is nearing capacity, it will enter a fail-safe mode informing the patient to turn off the machine. Once off, the IPC device 100 will automatically erase and restart the operating system with clean memory. This fail safe can be in a variety of forms, including but not limited to, the device beeping, a flashing message on the user interface 118, a message to prescriber, a message to authorized user, a voice command, etc.

After each use, the device will attempt to upload the data obtained during operation. An automatic upload can be scheduled within the software of the device. In one embodiment, the device will upload the operating data at ten minute intervals during treatment. However, when the upload is not possible, the device will save the data to an internal non-volatile memory. This circumstance may arise with an elderly at-home patient whom does not have internet access. If the PCD cannot upload compliance data over a thirty day period, the device will regularly alert the patient to insert a USB flash drive or some other storage device. The alert may be in the form of a noise (i.e. beeping), a message on the user interface 118, a voice command, etc. After two months without uploading the compliance data, the device will go into a fail-safe mode and not operate until the data is uploaded or transferred to another memory device. Once the data has been transferred and with the IPC device's 100 memory cleared, the device will resume normal operation. The device will upload all data when it is turned off as long as it is still plugged into a power source. When the power control 122 is turned off, the computer will remain on for approximately five seconds to upload the data and close all files properly so no data is lost or corrupted. To help prevent the patient from unplugging the device immediately after turning off the power, a screen may provide a message requesting the device remain plugged into a power outlet until the transfer of data is complete. In another embodiment, the speaker 126 may issue a command to leave the device plugged in until the upload is complete.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected.

1-30. (canceled)

30. An intermittent pneumatic compression apparatus for treating circulatory insufficiency in a limb of a patient, comprising:
an inflatable cuff sized to encircle at least a portion of the limb;
a blower configured to deliver air to the cuff through a passageway;
the cuff is pneumatically connected to the blower;
an electronic controller coupled to the blower; and
a user interface;
wherein the controller stores, for each of a plurality of disease-specific treatment modes, a respective operating envelope that defines a permitted sub-range for at least two treatment parameters selected from: (i) air pressure range, (ii) compression interval, (iii) cycle period between consecutive compressions, or (iv) total cycle time;
wherein the user interface is configured to present, for selection, treatment modes corresponding to at least three different circulatory insufficiencies selected from the group consisting of: arterial insufficiency, venous insufficiency, lymphatic insufficiency and deep vein thrombosis,
wherein, in response to selection of one of the treatment modes, the controller automatically constrains user-adjustable values for at least two of said treatment parameters to lie within the operating envelope's sub-range stored for the selected treatment mode and inhibits selection of values outside that sub-range, and
wherein the user interface allows for selection of a specific value within the sub-range for said at least two of said treatment parameters.

31. The intermittent pneumatic compression apparatus of claim 31, wherein the controller further has a protected setup state in which an authorized person selects, within the constrained operating envelope of the selected treatment mode, fixed values for at least said two treatment parameters and a treatment duration, and thereafter activates a lockout state, and wherein, while the lockout state is active, the controller prevents a patient from changing the selected treatment mode or the fixed values of said at least two treatment parameters and of the treatment duration, and permits only initiation and termination of treatment sessions via the user interface.

32. The apparatus of claim 31, wherein the user interface is configured to present treatment modes corresponding to all four of: arterial insufficiency, venous insufficiency, lymphatic insufficiency and deep vein thrombosis.

33. The apparatus of claim 31, wherein the operating envelope for treatment of arterial insufficiency restricts the air pressure range to between about 80 and about 120 mm Hg, restricts the compression interval to between about 0.35 and about 0.55 seconds, and restricts the cycle period to between about 1 and about 5 seconds.

34. The apparatus of claim 31, wherein the operating envelope for treatment of venous insufficiency restricts the air pressure range to between about 60 and about 100 mm Hg, restricts the compression interval to between about 0.45 and about 0.60 seconds, and restricts the cycle period to between about 1 and about 5 seconds.

35. The apparatus of claim 31, wherein the operating envelope for treatment of lymphatic insufficiency restricts the air pressure range to between about 30 and about 60 mm Hg, restricts the compression interval to between about 0.60 and about 0.80 seconds, and restricts the cycle period to between about 1 and about 5 seconds.

36. The apparatus of claim 31, wherein for a treatment mode corresponding to deep vein thrombosis the controller is further configured to:
(i) command the blower to produce three consecutive compression cycles at a cycle period between about 1 and about 5 seconds, each compression cycle having an air pressure range between about 30 and about 60 mm Hg and a compression interval between about 0.60 and about 0.80 seconds; and
(ii) after said three consecutive compression cycles, maintain the cuff at substantially ambient pressure for a pause interval that exceeds the combined duration of said three consecutive compression cycles.

37. The apparatus of claim 31, wherein the user interface comprises a touchscreen integrated into an electronic visual display, and the touchscreen is configured to present selectable graphical icons corresponding to the treatment modes.

38. The apparatus of claim 31, wherein the controller further comprises:
non-volatile memory for storing time-stamped records of treatment sessions including at least the selected treatment mode, the fixed values of the at least two treatment parameters, and the actual session duration; and
an upload module configured to transfer said time-stamped records to an external storage device or remote server when a wired or wireless communication path is available.

39. The apparatus of claim 39, wherein the controller is further configured to:
monitor an amount of time since a last successful upload of the time-stamped records, and
upon detecting that said amount of time exceeds a predetermined limit, prompt the patient via the user interface to connect a removable memory device to a Universal Serial Bus (USB) connector of the apparatus, and, if such connection is not made within a second predetermined limit, prevent initiation of further treatment sessions until either the time-stamped records have been successfully uploaded or transferred to the removable memory device.

40. The apparatus of claim 33, wherein entry into the protected setup state and deactivation of the lockout state each require presentation of authentication information supplied via an access device selected from the group consisting of: a hardware key connected through a USB port, a remote computing device communicating over a wireless data link, or a network-connected server implementing a two-factor authentication procedure.

41. A method of operating an intermittent pneumatic compression system to provide disease-specific therapy, the system including an inflatable cuff, a blower, a controller and a user interface, the method comprising:
presenting, on the user interface, selectable treatment modes that correspond respectively to at least three different circulatory insufficiencies selected from the group consisting of arterial insufficiency, venous insufficiency, lymphatic insufficiency and deep vein thrombosis;
selecting one of the treatment modes, wherein, in response to the selection, the system automatically limits, to a stored disease-specific operating envelope associated with the selected treatment mode, permissible values for at least two treatment parameters selected from: peak cuff pressure, compression interval, and cycle period,
selecting within the limited operating envelope, fixed values for said at least two treatment parameters and a total treatment time; and
starting treatment.

42. The method of claim 42 further comprising activating a lockout state in which modification of the selected treatment mode and of the fixed values is inhibited unless an access credential is provided.

43. The method of claim 43, wherein activating the lockout state comprises receiving, from a Universal Serial Bus (USB) key inserted into a USB port of the system, a first authentication token and receiving, via the user interface, a second authentication token, and enabling the lockout state only if both tokens are verified.

44. An inflatable cuff for use with an intermittent pneumatic compression device, the cuff comprising:
a flexible body sized and shaped to wrap around at least a limb of a wearer and define an interior patient-contacting surface and an exterior surface;
an inflatable bladder disposed in the flexible body and configured, when connected to a source of pressurized air, to sustain an internal pressure;
at least one hook-and-loop fastening assembly disposed on the flexible body and extending circumferentially so as to permit adjustment of a circumference of the cuff and thereby adjust the cuff to fit around the limb of the wearer; and
a zipper having a first row of interengaging elements secured to a first region of the flexible body and a second row of interengaging elements secured to a second region of the flexible body such that, when the zipper is closed, the dimensions of the cuff are mainted,
wherein the zipper can be opened to allow the cuff to be removed from the wearer's limb while leaving the hook-and-loop fastening assembly engaged at its previously adjusted position, and
wherein after the cuff is placed back around the wearer's limb, closing the zipper restores substantially the same circumference defined by the previously adjusted position of the hook-and-loop fastening assembly without readjustment of the hook-and-loop fastening assembly.

45. The inflatable cuff of claim 45, wherein the flexible body further comprises at least one transparent or translucent window at a toe region of the cuff aligned to permit visual inspection of at least the wearer's toes during use.

46. The inflatable cuff of claim 46, wherein the flexible body further comprises a second transparent or translucent window at a heel region of the cuff aligned to permit visual inspection of the wearer's heel during use.

47. The inflatable cuff of claim 45, wherein the zipper extends only along a portion of a longitudinal length of the cuff between a plantar region underlying the wearer's foot and a proximal calf region, such that an end of the zipper terminates short of a proximal edge of the cuff.

48. The inflatable cuff of claim 45, further comprising a swivel air-hose coupling mounted to the cuff at a location offset from an underside of the wearer's foot so that, with an air hose attached to the coupling, the wearer can stand or ambulate while the cuff remains connected to the intermittent pneumatic compression device.

49. The inflatable cuff of claim 45, in combination with a disposable extremity glove configured to be worn on the wearer's foot under the interior patient-contacting surface of the cuff, the glove being formed of a thin, substantially incompressible material to reduce soiling of the cuff while not materially attenuating the compression delivered by the inflatable bladder.
